(19) United States
(12) Patent Application Publication
(10) Pub. No.: US 2011/0255752 A1
(43) Pub. Date: Oct. 20, 2011

(54) EVALUATION METHOD AND DEVICE FOR EVALUATION OF MEDICAL IMAGE DATA

(76) Inventor: Bjoern Heismann, Erlangen (DE)

(21) Appl. No.: 13/086,596

(22) Filed: Apr. 14, 2011

(30) Foreign Application Priority Data
Apr. 16, 2010 (DE) 10 2010 027 878.5

(51) Int. Cl. G06K 9/00

(52) U.S. Cl. 382/128

(57) ABSTRACT

In an evaluation method and device for evaluation of medical image data, a pre-selection step is implemented for a manual pre-selection of the medical image data and a selection step is implemented for manual selection of relevant image regions in the pre-selected medical image data. Information for the selection of relevant image regions is provided in a manner that is at least partially computer-controlled in the preparation step.

### BACKGROUND OF THE INVENTION

1. Field of the Invention

The invention concerns an evaluation method for an evaluation of medical image data, comprising a pre-selection step for a manual pre-selection of the medical image data, and a selection step for manual selection of relevant image regions in the pre-selected medical image data.

2. Description of the Prior Art

In the evaluation and/or assessment of medical image data, in particularly radiological image data, it is required that a user (in particular a physician, for example a radiologist) must evaluate and/or assess a plurality of individual medical images. However, this evaluation and/or assessment is very time-intensive.

To assist the user, a computer-aided diagnosis is known by means of which data analyses and/or data evaluations of image data are implemented and the quantitative information for a medical diagnosis can be provided. However, these computer-aided analyses tend to generate a high number of false findings that must subsequently be individually considered and corrected by the user. This leads to an additional workload for the user. In addition to this, for legal reasons a decision made by the user must always exist for a diagnosis.

### SUMMARY OF THE INVENTION

An object of the present invention in is to provide an evaluation method for an evaluation of medical image data in which a fast evaluation for medical image data can be achieved while avoiding incorrect findings.

The invention is an evaluation method for evaluation of medical image data, including a pre-selection step for a manual pre-selection of the medical image data and a selection step for a manual selection of relevant image regions in the pre-selected medical image data.

In a preparation step, information for the selection of relevant image regions are provided in an at least partially computer-controlled manner. Medical image data in this context are image data that are generated by means of a medical imaging device, for example a magnetic resonance tomography device, a computed tomography device or a PET device. Furthermore, a manual pre-selection means a pre-selection of the medical image data that is conducted by a user, for example a radiologist. The individual medical images are selected manually according to according to a distinctive feature and/or disturbance. A manual selection of relevant medical image regions means a selection made by the user in which a region and/or area responsible for the conspicuity and/or the disruption is selected from the pre-selected medical image data. The pre-selection step and/or the selection step are advantageously made by the user at a computer console, wherein the selection takes place by means of a marking element, for example a computer mouse. For example, the selection can take place via a movement of a computer mouse. For example, the selection can take place via a movement of the computer mouse over an image content. The information provided in the preparation step can also be formed by a signal-to-noise ratio, a similar texture property (for example an entropy), an energy, a roughness, a directionality etc. In addition to this, the information can contain an edge detection or a detection of basic shapes such as star-shaped lesions etc. Combinations of individual criteria and/or values are conceivable for the provision of information. Through the embodiment according to the invention, a simple access to additional information regarding a conspicuity and/or disruption detected by the user can advantageously be obtained so that this information can be retrieved at any time by the user for an additional evaluation and/or assessment of the individual image regions. Such a particularly fast data evaluation can be achieved for the relevant image region, and in addition to this such misdiagnoses (caused by a computer-assisted diagnosis) can be reduced or prevented.

Furthermore, in accordance with the invention at least one item of information is displayed in the preparation step, so a direct information transfer to the user can take place. For example, the selection can be detected (in particular automatically) by an evaluation unit by residence of a mouse pointer in a relevant image region, and a presentation of the information can thereupon be generated automatically by the evaluation unit in that, for example, an information window with information for the relevant image regions is opened and is displayed on a monitor for the user. The information is preferably provided in real time for the user. In addition, it is also possible for the evaluation unit to retain the information for retrieval so that the user can retrieve this information as needed for the graphical representation.

In the preparation step, an automatic marking of at least one relevant marking region particularly advantageously takes place in real time depending on the selection of relevant image regions. The marking of at least one relevant marking region is advantageously conducted by the computer. By the marking of one or more relevant marking regions, the regions with a conspicuity and/or disruption within the image regions that are selected by the operator as relevant, which regions with a conspicuity and/or disruption are determined by the computer, can be displayed to the user.

Also in accordance with the invention, the selection of an image region takes place with a uniform property in the selection step. A region with a uniform property means an optimally homogeneous tissue region of an examination subject, in particular of a patient, for example a liver region and/or a lung region etc., such that an aberration and/or a disruption can be detected.

Furthermore the invention encompasses a medical evaluation device for an evaluation method, in particular for an evaluation of medical image data.

### BRIEF DESCRIPTION OF THE DRAWINGS

FIG. 1 illustrates an evaluation method according to the invention.

FIG. 2 schematically illustrates a medical evaluation device according to the invention in a schematic representation.

### DESCRIPTION OF THE PREFERRED EMBODIMENTS

A medical evaluation device 10 according to the invention is shown in FIG. 2. The medical evaluation device 10 is provided together with a user (for example a physician, in particular a radiologist) for an evaluation of medical image data. The medical image data are acquired by means of a medical imaging device 14, which can be a magnetic resonance tomography device, a computed tomography device, an ultrasound device etc. For an evaluation of the medical image data, these are transferred from the medical imaging device 14 to the medical evaluation unit 10 and stored there in a memory unit (not shown in detail).

The medical evaluation unit 10 additionally includes a computer 11, a marking element 13 and a display unit 12. The marking element 13 is formed by a computer mouse. The display unit 12 is provided to display the medical image data and for this is formed by a monitor and/or a display. An alternative embodiment of the marking element 13 and/or the display unit 12 is conceivable at any time in an additional embodiment of the invention.

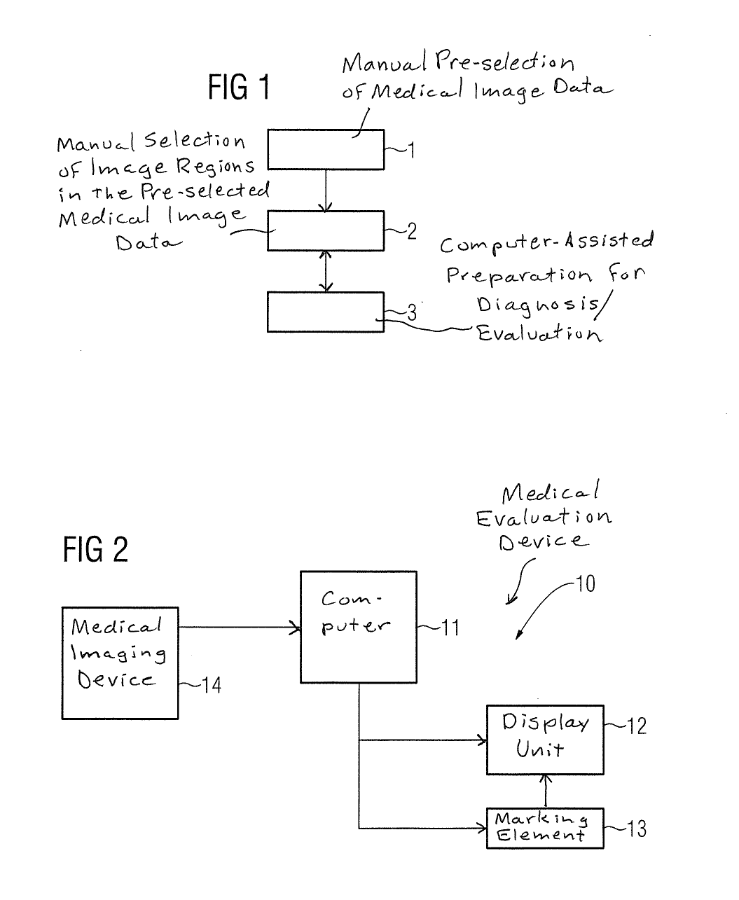

In the medical evaluation method according to the invention (FIG. 1), to evaluate medical image data a pre-selection of the medical image data initially takes place in a pre-selection step 1. The pre-selection is conducted manually by the user. From a plurality of medical image data that are formed by individual medical images, the user hereby selects those that—according to an estimation by the user—exhibit a conspicuity and/or a disruption.

In a selection step 2 following the pre-selection step 1 the user makes a manual selection of relevant medical image regions in these pre-selected medical image data. Within the pre-selected image data or the pre-selected images, the user selects those image regions with a conspicuity and/or a disruption. This is advantageously a region with a uniform property, for example an acquisition region of a liver, a lung etc. in which the disruption and/or the conspicuity is arranged. The selection takes place using the marking element 13, by the user marking the relevant medical image regions by means of the marking element 13. The marking can be made actively by the user, or can be caused by the residence of a mouse pointer in the relevant image region and/or by a movement of the mouse pointer over the relevant image region, in that the computer interprets this residence and/or this movement of the mouse point as a selection of the relevant medical image region.

In a preparation step 3 for diagnosis and/or evaluation following the selection step 2, information is provided for the selection of the relevant image regions, wherein the preparation step 3 runs in a computer-controlled manner. The preparation step 3 is automatically generated by the computer 11 after the selection step 2. The information provided in the preparation step 3 is determined by the computer 11 by means of a computer-assisted diagnosis from the relevant medical image data. The computer 11 can determine the information after the selection step 2 or have already determined the information after a creation of the medical image data, and can subsequently retain these (for example in the memory unit) for the evaluation method.

In the preparation step 3, at least one item of information is automatically displayed to the user by the computer 11 by means of the display unit 12. Relevant marking regions are thereby initially marked in real time by the computer 11, which marking regions are arranged within the image regions that are selected as relevant by the user. These relevant marking regions are formed by regions in which a conspicuity and/or disruption was determined by the computer 11 by means of the computer-assisted diagnosis. In addition to this, additional information that the computer 11 has determined by means of the computer diagnosis can be displayed; for example, the marking region can be presented with homogeneous image values up to a maximum percentile and/or absolute deviation relative to a reference value. In addition to this, the provided information can comprise each conspicuity and/or detected variable recognized by the computer 11, for example a homogeneous signal-to-noise ratio and/or similar texture properties (for example an entropy, an energy, a roughness, a directionality etc.). Furthermore, information about an edge detection or a detected basic shape (for example a star-shaped lesion etc.) can be provided. A combination of multiple information values is also possible.

This information can additionally be presented to the user automatically by the computer 11 next to the mouse pointer in an information display window on the display unit 12. The provided information can additionally contain another diagnostic recommendation that is additionally provided with a probability indicator. By means of the probability indicator, the user receives a probability (determined by the computer 11) for an accuracy of the diagnostic recommendation. The information provided by the computer 11 serves only to assist the user; the user always makes a decision with regard to a diagnosis.

Furthermore, instructions can be automatically communicated to the user by the computer 11 by means of the provision of information, for example instructions regarding the areas classified by the computer 11 as conspicuous, which areas adjoin the image data that the user selected as relevant in the selection step 2. In addition to this, this information can also contain instructions for an improved presentation of the relevant image regions, for example an enlarged or a reduced presentation.

As an alternative, the information can be provided by the computer 11 only so that the user can retrieve said information at any time.

Although modifications and changes may be suggested by those skilled in the art, it is the intention of the inventor to embody within the patent warranted hereon all changes and modifications as reasonably and properly come within the scope of his contribution to the art.

I claim as my invention:

1. An evaluation method for evaluating medical image data, comprising the steps of:
supplying medical image data to a computer and, via a user interface of the computer, manually making a pre-selection of pre-selected medical image data from among the medical image data supplied to the computer;
also via said user interface, making a manual selection of at least one relevant image region in the pre-selected medical image data; and
in said computer, generating assistance information to assist in the selection of said at least one relevant image region, and making the computer-generated assistance information available via said user interface contemporaneously with said selection of said at least one relevant image region.

2. An evaluation method as claimed in claim 1 comprising visually displaying said computer-generated assistance information at a display of said user interface.

3. An evaluation method as claimed in claim 1 comprising generating said assistance information as an automatic marking of at least one relevant marking region dependent on the selection of said at least one relevant image region.

4. An evaluation method as claimed in claim 1 comprising selecting, as said at least one relevant image region, an image region exhibiting a uniform property.

5. An computerized medical evaluation device, comprising:
a computer supplied with medical image data, said computer having a user interface configured to allow a user to manually make a pre-selection of pre-selected medical image data from among the medical image data supplied to the computer;
said user interface also being configured to allow a user to make a manual selection of at least one relevant image region in the pre-selected medical image data; and
said computer being configured to automatically generate assistance information to assist in the selection of said at least one relevant image region, and to make the computer-generated assistance information available via said user interface contemporaneously with said selection of said at least one relevant image region.
